(19) United States
(12) Patent Application Publication
(10) Pub. No.: US 2009/0307739 A1
(43) Pub. Date: Dec. 10, 2009

(54) REMOTE DISTRIBUTED ANTENNA

(75) Inventors: Richard Finch Dean, Lyons, CO (US); Paul E. Jacobs, La Jolla, CA (US); Daniel H. Agre, Rancho Santa Fe, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/133,597

(22) Filed: Jun. 5, 2008

(51) Int. Cl. H04N 7/173; H04N 5/38

(52) U.S. Cl. 725/118; 348/723; 725/131

(57) ABSTRACT

Methods and apparatus are described for configuring a CATV system as base station with a distributed antenna supporting a wireless communication system. The CATV system can be configured to implement a frequency translating repeater at each of a plurality of distribution points within the CATV distribution network.

### BACKGROUND

1. Field of the Invention

The invention relates to wireless communications. More particularly, the invention relates to wireless communications utilizing a distributed antenna based on a wired signal distribution system.

2. Description of Related Art

Wireless communication systems are presented with a wide range of difficult operating conditions over which a quality communication link is to be established. In point to point wireless links, the limited two way communication links can be optimized for channel conditions. However, in systems that are point to multi-point, such as most cellular telephone communication systems, optimization of every communication link to accommodate the wide range of operating conditions and varying channel conditions may not be possible.

Physical obstacles may operate to degrade channel conditions beyond an optimization range of a base station or subscriber station. Physical obstacles that may operate to degrade or otherwise obscure communications include physical terrain, buildings, landscape, and walls. A wireless communications system may be particularly taxed when attempting to provide quality communications to indoor users. Users in poor coverage areas may be referred to as being in coverage holes.

Attempts to improve the performance of a wireless communication system and eliminate coverage holes have been accomplished by deploying additional hardware. For example, additional cellular towers may be added to a system to improve coverage. Alternatively, or additionally, repeaters may be employed to increase the coverage area, but often do not work well. Miniature base station hardware, termed femtocells, are being proposed, but these could be expensive, as dedicated silicon (processing) is required for each femtocell.

There remains the problem of in-home or in-building coverage or otherwise providing communications support in coverage holes. Femtocells and wireless repeaters are not particularly cost effective and require deployment of specialized hardware.

### BRIEF DESCRIPTION OF THE DRAWINGS

The features, objects, and advantages of embodiments of the disclosure will become more apparent from the detailed description set forth below when taken in conjunction with the drawings, in which like elements bear like reference numerals.

FIG. 1 is a simplified functional block diagram of an embodiment of a cable television system with a distributed antenna for wireless communications.

FIG. 2 is a simplified functional block diagram of an embodiment of a wired system with a distributed antenna.

FIG. 3 is a simplified functional block diagram of an embodiment of a radio access device.

FIG. 4 is a simplified flowchart of an embodiment of wireless access using a distributed antenna.

FIG. 5 is a simplified flowchart of an embodiment of reverse link signal processing in a distributed antenna.

### DETAILED DESCRIPTION OF EMBODIMENTS OF THE INVENTION

A form of distributed antenna is described herein for providing coverage in a building, home, or area that does not have coverage from the outdoor macro cellular system. The methods and apparatus for signal distribution of wireless communication signals described herein are different from prior solutions in the area of cost and trunking efficiency. The methods, apparatus, and system described herein are lower in cost because the processing is kept to a minimum in the home. The signal distribution system includes sufficient hardware in the home, in the form of a radio access device, to translate the frequency of the wireless communication system (such as a cellular system having any band assignment, 800, PCS, 2100 etc) to a band that could be transported on a cable TV plant (CATV) or fiber to the home plant (FTTH). By keeping the hardware in the home simple frequency translation, and having the base station complexity in a centralized location, such as the headend, the in-home cost is minimized. Demand in the home or building is typically low, thus it is not cost efficient to have dedicated call processing resources in the home or building. By using the CATV or FTTH system to aggregate the calls back to the centralized base station the trunking efficiency of the system is increased, thus lowering the overall system cost. It is possible in Code Division Multiple Access (CDMA) systems to detect calls based on the rise-over-thermal (ROT) at the receiver antenna. It is desirable to limit the accumulation of noise at the receiver when many receivers are summed. Thus, the ROT can be used to activate the reverse link or uplink path to the base station that is processing the user signal. ROT switching will increase the trunking efficiency of the reverse link path.

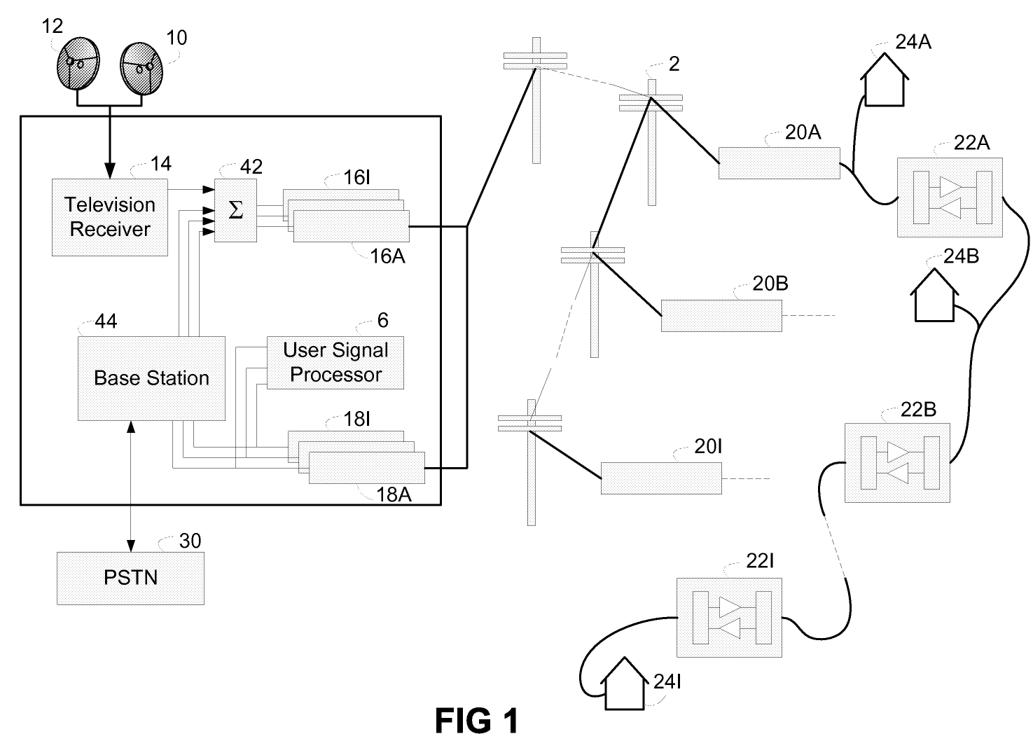

FIG. 1 is a simplified functional block diagram of an embodiment of a cable television system with a distributed antenna for wireless communications. Satellite signal antennas 10 and 12 receive television (TV) signals typically in the Ku or C band frequency range at headend 4. TV receiver 14 within headend 4 converts the signals to the lower RF frequencies for transmission throughout the cable system. Typically, downstream TV signals are carried within the frequency range of 54 MegaHertz (MHz) to 550 MHz.

The headend 4 can also include a base station 44. Base station 44 interfaces the wireless communication network with public switched telephone network (PSTN) 30. In addition base station 44 provides for the generation of the forward link signals, such as code division multiple access (CDMA) call signals as well as pilot and other overhead signals which are distributed on the downstream link. Base station 44 also provides for the selection or combination of the reverse link CDMA call signal and overhead signals as received on the upstream link.

The base station 44 may operate similar to a base station (not shown) that is deployed in a conventional wireless communications system, with some exceptions. Rather than directly interfacing with over-the-air communications, the base station interfaces with the wireless communication signals using the distributed antenna that can include the wired distribution system and several radio access devices at terminations of the wired distribution system. Additionally, the base station 44 can be configured to couple the signals to and from the wired distribution system in frequency bands that are distinct from the frequency bands specified in a wireless communication system supported by the base station 44.

The electrical RF signals output from TV receiver 14 can be combined with the forward link signals from a base station 44 positioned at the central location, and the aggregate forward link signals can be passed to a bank of electrical to optical signal converters 16A-16I. Each of electrical to optical signal converters 16A-16I converts the electrical RF signals to optical signals for fiber optic transmission to a subset of the geographical coverage areas serviced by a plurality of fiber nodes 20A-20I. For example, fiber 2 carries the optical signals from electrical to optical signal converter 16A to fiber node 20A. Fiber nodes 20A-20I are spaced throughout the geographic area serviced by the signal from fiber 2. Each of fiber nodes 20A-20I provides the signal through electrical signal cable to a plurality of destinations 24A-24I, such as houses, apartment buildings, and businesses. Each of the plurality of destinations 24A-24I can include terminating hardware that provides local interface to the wireless communication signals.

Located along the length the electrical signal cable are a plurality of bi-directional amplifiers 22A-22I, alternatively referred to as bridging amps. The electric signal cable and amplifiers may also be arranged in a parallel and/or star configuration rather than the series configuration shown in FIG. 1.

The path of the TV signal from headend 4 to destinations 24A-24I is referred to as the downstream path. The corresponding path from the base station 44 to the destinations 24A-24I is referred to as the forward link path. Typically, a city with a population of about 1 million people has three or four headends. The fiber lines, such as fiber 2, run long distances in underground conduits or above ground poles. From each fiber node 20A-20I, the electric signal cables usually run about a mile or less depending on the number of destination. Bi-directional amplifiers 22A-22I may be inserted every 1000 feet along the electrical signal cable. Typically, no more than five bi-directional amplifiers are cascaded along any one electrical signal cable due to the intermodulation distortion added by each amplifier.

The Federal Communication Commission (FCC) regulations require that the cable plant provide bi-directional communication with the destinations. As such, in addition to the downstream system providing TV signals to the destination, an upstream system provides an uplink signaling path from destinations 24A-24I back to headend 4. The upstream path is typically intended to carry a much lower volume of signaling traffic than the downstream path. The upstream path may be used, for example, to indicate the selection of a “pay-per-view” option by a user.

The upstream link operates essentially the same as the reverse of the downstream link. Typically, the upstream link operates on a more limited frequency range such as from 5-40 MHz. Signals from destinations 24A-24I are carried via the electrical signal cable and bi-directional amplifiers 22A-22I to fiber node 20A. At fiber nodes 20A-20I, the signals are converted from the electrical form to optical form for transmission on fiber 2. At headend 4, the upstream signals are converted to electrical form by optical to electrical signal converters 18A-18I. The upstream signal are then processed by user signal processor 6.

In typical configurations, there is a one to one mapping between electrical to optical signal converters 16A-16I and fiber nodes 20A-20I. A unique fiber within fiber 2 carries each downstream and upstream signal separately.

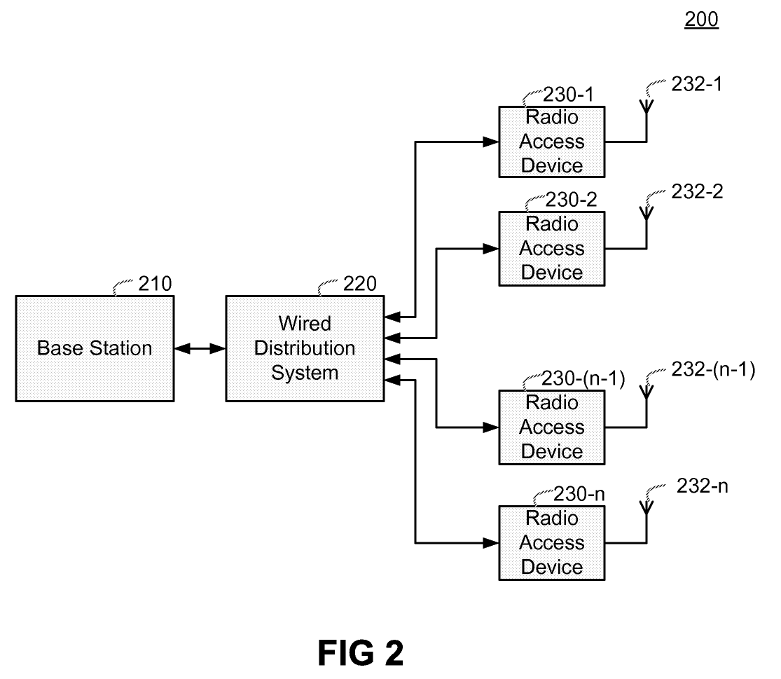

FIG. 2 is a simplified functional block diagram of an embodiment of a signal distribution system 200 including a wired system with a distributed antenna. The signal distribution system 200 can be, for example, the cable TV system illustrated in FIG. 1. The signal distribution system 200 illustrated in FIG. 2 is limited to those elements that are relevant to supporting wireless communications, such as telephone communications.

The signal distribution system 200 includes a base station 210 that operates as the interface from the signal distribution system 200 to an external wired communication system, such as a PSTN (not shown). The base station 210 can support, for example, communications substantially in accordance with a wireless communication standard, such as a cellular telephone standard or a personal communication system standard.

The base station 210 can be substantially similar to other base stations deployed within the wireless communication system with some differences for operating with the distributed antenna. The base station 210 may interface, for example, with a mobile switching center (MSC) or some other control center or gateway that connects the base station 210 to the PSTN and manages the communications to and from the base station 210.

The base station 210 can be configured to operate in forward link and reverse link frequency bands that differ from those operating frequency bands utilized by other base stations not implementing a distributed antenna. The base station 210 couples the forward link signals to a wired distribution system 220.

The wired distribution system 220 can include, for example, copper wires, fiber optic links, and the like, or some combination thereof for distributing the signals across a service area. The wired distribution system 220 can be configured to distribute signals in addition to the communication signals interfacing with the base station 210. For example, the wired distribution system 220 can be a cable television distribution system, and the forward link communication signals from the base station 210 can be summed or otherwise combined with television signals. Similarly, the wired distribution system 220 may be a bi-directional communication system, and the reverse link signals destined for the base station 210 may be summed or otherwise combined with uplink signals in the wired distribution system 220

The wired distribution system 220 can multiplex the base station signals with the other signals, such as cable television signals, using virtually any type of supported multiplexing technique or combination of multiplexing techniques. For example, the wired distribution system 220 may frequency division multiplex the base station signals with cable television signals.

The wired distribution system 220 can be configured to distribute the multiplexed signals to various destinations. A plurality of the destinations can include a radio access device 230 and antenna 232 as an element in a distributed antenna. For example, the wired distribution system can couple signals to a first radio access device 232-1 interfacing with a first antenna 232-1, a second radio access device 232-2 interfacing with a second antenna 232-2, through to an (n−1) radio access device 232-(n−1) interfacing with an (n−1) antenna 232-(n−1), and an nth radio access device 232-n interfacing with an nth antenna 232-n.

Each radio access device 230 can be configured to extract the forward link base station signals and frequency convert them to a forward link operating band. Each radio access device 230 can couple the forward link signal to the corresponding antenna 232 for transmission. In the reverse link, the antenna 232 can be configured to receive the wireless signals in a reverse link operating band, and can be configured to frequency convert the signal to a distinct operating band for transmission back to the base station 210. Each radio access device 230 can also be configured to multiplex the frequency converted reverse link signals with uplink cable signals including uplink user signals, such as user control and feedback in a cable television system.

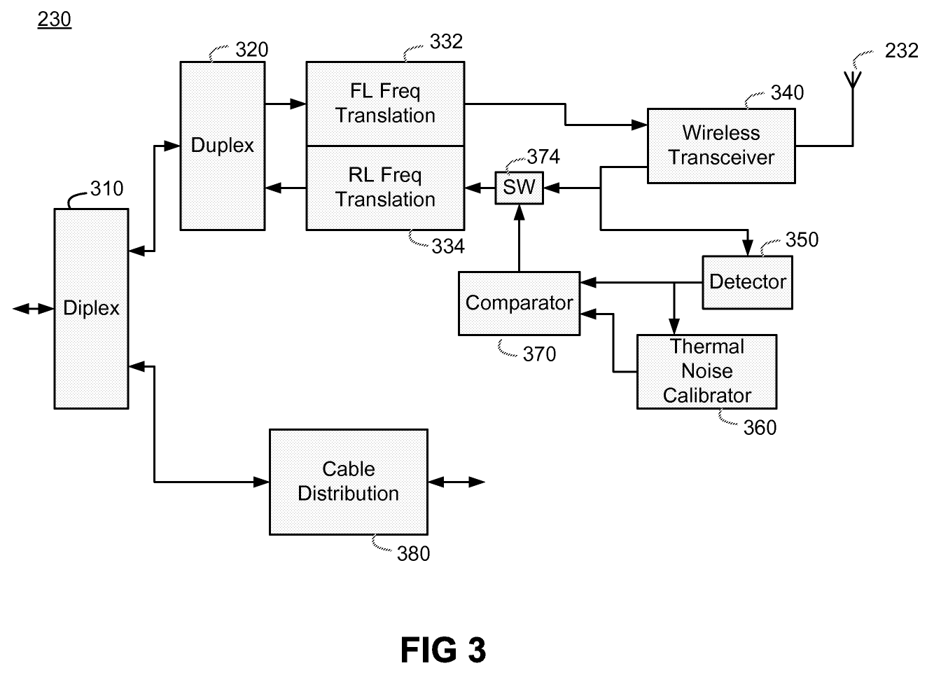

FIG. 3 is a simplified functional block diagram of an embodiment of a radio access device 230. The radio access device 230 can be, for example, one of the radio access devices in the distributed antenna configuration of FIG. 2 or a radio access device in the system of FIG. 1.

The radio access device 230 includes a wireless interface to support wireless communications and includes a wired interface for distributing content and receiving control and feedback. The signals to and from a base station are multiplexed with the wired content and at an operating frequency supported by the wired distribution system.

The radio access device 230 includes a multiplexer/demultiplexer coupled to the wired distribution system. In the embodiment of FIG. 3, the multiplexer/demultiplexer is implemented as a diplexer 310. The diplexer 310 operates as a frequency division demultiplexer in the forward link or downlink direction. The diplexer 310 demultiplexes the aggregate forward link signals by separating or otherwise extracting the forward link signals from the wired content, which can be, for example, cable television content. The diplexer 310 couples the forward link signals to the wireless communication processing portion of the radio access device 230. The diplexer 310 also couples the separated cable television content to a cable television distribution portion 380 of the radio access device 230.

The cable television distribution portion 380 can operate to amplify and filter the downlink signal for output on a television. The cable television distribution portion 380 can be a bi-directional device that operates to receive user input, control, or uplink data and transmit it back to the headend, via the wired distribution system.

In the reverse or uplink direction, the diplexer 310 operates as a multiplexer to combine the uplink control information from the cable television system with the reverse link signals that are positioned within a distinct frequency band from the uplink control information to generate a composite uplink signal. Thus, the diplexer 310 combines the signals to frequency division multiplex the uplink signals with the reverse link signals.

The wired distribution system (not shown) may not support the operating frequency band of the wireless communication system. Therefore, the wired distribution system may distribute a frequency translated version of the wireless communication system. In the forward link direction, the forward link signals provided by the wired distribution system can be frequency offset forward link signals, where the frequency offset represents the difference between the RF operating frequency of the forward link signal and the frequency of the forward link signal carried by the wired distribution system. Similarly, in the uplink direction, the wired distribution system can carry a frequency translated reverse link signal, which can be a frequency translated version of the RF receive signals in the wireless communication system.

In one embodiment, when supporting a Frequency Division Duplex (FDD) wireless communication system, the wired distribution system can maintain the frequency separation between forward link and reverse link RF bands, such that both the forward link and reverse link signals may be frequency translated using a single local oscillator frequency. In another embodiment supporting FDD wireless communication system, the wired distribution system need not maintain the spectral spacing between the forward link and reverse link RF bands. In such an embodiment, the forward link signals may be frequency translated by an offset frequency that is distinct from an offset frequency introduced by frequency translation of the reverse link signals. Indeed, in one embodiment, where the wired distribution system has sufficient bandwidth, the forward link wireless communication signals need not even be frequency translated prior to distribution in the wired distribution systems.

The frequency translated wireless communication signals are communicated between the diplexer 310 and a duplexer 320. The duplexer 320 can operate to couple the frequency offset forward link signals from the diplexer 310 to the forward link processing path, while the duplexer 320 operates to couple the frequency translated reverse link signals from the reverse link processing path to the diplexer 310 for transmission along the wired distribution system.

The forward link processing path includes a forward link frequency translator 332 configured to frequency convert the frequency offset forward link signals to the RF transmit frequency used by the wireless communication system. The output of the forward link frequency translator 332 is coupled to a wireless transceiver 340, and in particular to a transmitter within the wireless transceiver 340. In one embodiment, the forward link frequency translator 332 utilizes a mixer driven by a Local Oscillator (LO) to frequency convert the frequency offset forward link signals to the RF transmit frequency used by the wireless communication system. In another embodiment, the forwards link signals distributed by the wired distribution system are already at the RF transmit frequency and the forward link frequency translator 332 can be omitted. The transmitter further processes and amplifies the forward link signal for transmission using the antenna 232.

The reverse link processing path begins at the antenna 232. The antenna 232 couples the reverse link signals to the wireless transceiver 340. A receiver in the wireless transceiver 340 is configured to receive the reverse link signals. The receiver couples the reverse link signals to a switch 374 and to a signal metric module, shown in FIG. 3 as a detector 350. The switch 374 operates to selectively couple the reverse link signals to the uplink path based on a control provided to a switch control input.

The signal metric module operates to determine a signal metric value based at least in part on the reverse link signals. The signal metric value is used to determine whether the reverse link signals include signal content or if the reverse link signals are noise and interference. Valid reverse link signals should be transmitted to the base station at the headend. Distributing noise and interference to the base station only operates to degrade the signal level experienced by other users sharing the reverse link. Thus, the radio access device 230 selectively determines, based on the signal metric value, whether to send signals on the reverse link, and effectively dynamically determines whether to be an active element in the distributed antenna.

In the embodiment of FIG. 3, the signal metric module is implemented as a detector 350. The detector 350 can be configured to determine a received power of the reverse link signal. Other embodiments may implement different signal metric modules, and the use of a detector 350 and received power as the signal metric is illustrative and not a limitation.

The output of the detector 350 is coupled to a first input of a comparator 370. A predetermined threshold value is coupled to the second input of the comparator 370. The predetermined threshold can be fixed or can be dynamically determined. In the embodiment of FIG. 3, the predetermined threshold is generated dynamically by a thermal noise calibrator 360. The thermal noise calibrator 360 determines a threshold based on a level of noise in the reverse link band, and can base the threshold on the thermal noise in the reverse link band.

In one embodiment, the thermal noise calibrator 360 determines a threshold to permit the comparator 370 to make a signal presence decision based on a desired rise-over-thermal (ROT). The radio access device 230 can be configured to support a relatively small geographic area, and which may have sparse loading, similar to a wired telephone in a home.

Thus, the thermal noise calibrator 360 can be configured to determine a noise threshold that corresponds to a relatively large ROT value. For example, the thermal noise calibrator can set a threshold equal to approximately 3 dB, 6 dB, 10 dB, 20, dB or more over the measured thermal noise value.

The ROT is a ratio between the total power in the reverse link (Pr) and the thermal noise power (N) that is received at the receiver. The noise power changes throughout the day due to environmental factors. Thus, to maintain a selected ROT characteristic, the noise power in the network needs to be measured throughout the day.

For example, one technique operates to measure the noise power by disabling transmissions from all the mobile stations communicating with a particular radio access device 230, so that the noise power received at the radio access device 230 can be measured. The noise calibration may be repeated several times per day in order to get accurate ROT measurements as the noise power changes.

The comparator 370 is thus configured to determine whether the reverse link signal achieves a ROT value that is indicative of a valid reverse link signal. If so, the comparator 370 controls the switch 374 to close, thereby coupling the reverse link signals to the uplink path.

The output of the switch 374 is coupled to a reverse link frequency translator 334 that can be configured to frequency convert the reverse link signals to a frequency translated reverse link signal in an uplink frequency band supported by the wired distribution system. The reverse link frequency translator 334 can perform frequency translation using, for example, a mixer driven by a LO. The LO can be the same or distinct from the LO used by the forward link frequency translator 332. The output of the reverse link frequency translator 334 is coupled to the duplexer 320 and then to the diplexer 310 for transmission along the wired distribution system back to the headend.

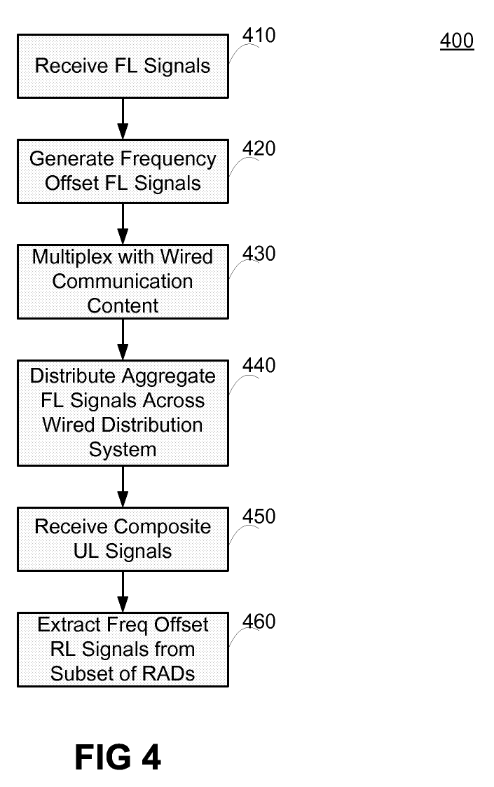

FIG. 4 is a simplified flowchart of an embodiment of a method 400 of wireless access using a distributed antenna. The method 400 can be implemented, for example, at the headend of a CATV system having a base station, such as shown in the system of FIG. 1.

The method 400 begins at block 410, where the headend receives forward link information, for example from a mobile station controller. The forward link information may be, for example, unmodulated forward link data or may be modulated RF forward link signals ordinarily transmitted by a base station.

The headend proceeds to block 420 and generates the frequency offset forward link signals based on the received forward link information. The base station within the headend, for example, may generate the frequency offset forward link signals in much the same manner as is normally performed for forward link signals, with the exception of the output frequency. The base station in the headend can generate the frequency offset forward link signals to coincide with a downlink frequency band supported by the wired distribution system.

The headend proceeds to block 430 and multiplexes the frequency offset forward link signals with wired communication content. For example, the headend can be a headend of a CATV system, and the headend can multiplex the frequency offset forward link signals with cable television content. The headend can be configured to, for example, frequency division multiplex the frequency offset forward link signals with cable television content, time division multiplex the frequency offset forward link signals with cable television content, or implement some other type of multiplexing or combination of multiplexing.

After multiplexing the signals to generate an aggregate forward link signal, which may also be referred to as an aggregate downlink signal, the headend proceeds to block 440 and couples the aggregate signal to a wired distribution system. The headend thus distributes the aggregate forward link signals across a wired distribution system.

The wired distribution system can be, for example, a CATV distribution system that includes copper line links, fiber optic links, or some combination thereof. Additionally, the wired distributions system can include one or more bridge amplifiers that operate to amplify the signals to extend the distribution network. The wired distribution system terminates at a plurality of radio access devices, as illustrated in FIG. 1. Each of the radio access devices can process the aggregate forward link signals and can selectively return a composite reverse link signal. Because each radio access device independently determines whether to include its reverse link signals in the uplink path, the composite reverse link signal from each radio access device may selectively omit the frequency translated reverse link signal.

The composite reverse link signal can include a frequency translated reverse link signal, uplink information that can include control information, or some combination thereof. The wired distribution system combines the composite reverse link signals from each radio access device and communicates it to the headend. As noted above, each radio access device independently determines whether to omit its locally received reverse link signals from the composite reverse link signals. Thus, the composite reverse link signal at the output of the wired distribution system obtained by combining the composite reverse link signals from each of the radio access devices will likely only have frequency translated reverse signals and uplink signaling from a subset of the radio access devices forming the distributed antenna. At any given instant, some radio access devices may not transmit any locally generated signals to the uplink of the wired distribution system. Other radio access devices may have uplink information but may have inhibited frequency translated reverse link signals. Still other radio access devices may transmit frequency translated reverse link signals, but may have no CATV uplink signals. Yet other radio access devices will contribute both frequency translated reverse link signals as well as CATV uplink signals. At block 450, the headend receives the composite reverse link signals.

The headend proceeds to block 460 and extracts the frequency offset reverse link signals from the subset of radio access devices that have included the signals. The headend direct the combination of extracted frequency translated reverse link signals to the base station for reverse link processing. The capacity of the base station is improved through the use of the selective reverse link signaling by the various radio access devices that are elements of the distributed antenna.

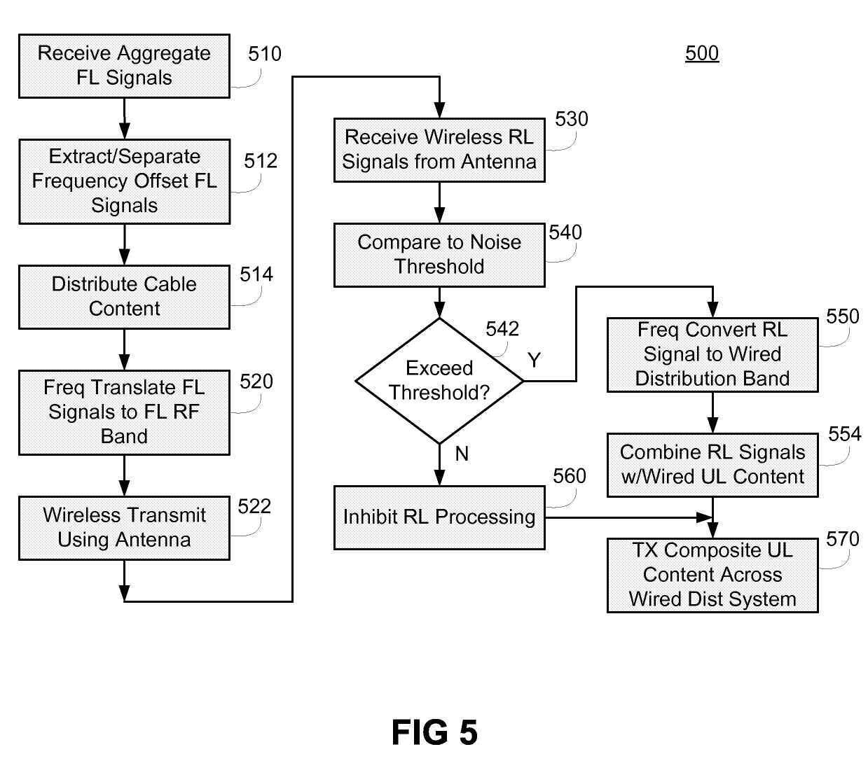

FIG. 5 is a simplified flowchart of an embodiment of a method 500 of reverse link signal processing in a distributed antenna. The method 500 can be implemented, for example, in a radio access device such as the radio access device of FIG. 3. The radio access device can be one of a plurality of radio access devices configured as a distributed antenna, as shown in the system of FIG. 1.

The method 500 begins at block 510, where the radio access device receives aggregate forward link signals from a wired distribution system to which it is connected. The aggregate forward link signals can include, for example, forward link signals, which may be frequency offset forward link signals, and cable television content. The radio access device proceeds to block 512 where it extracts, separates, or otherwise demultiplexes the frequency offset forward link signals from the cable television content. In one embodiment, the signal components of the aggregate forward link signals are frequency division multiplexed, and the radio access device separates the frequency offset forward link signals from the cable television content utilizing one or more filters. In another FDD embodiment, the radio access device utilizes a diplexer to demultiplex the signal components.

The radio access device proceeds to block 514 and distributes the cable content, for example, to the cable television processing portion of the radio access device. In one embodiment, the radio access device can be implemented as a CATV set top box, and the cable television processing portion can output a television signal or band of television signals at an output connector.

The radio access device proceeds to block 520 and frequency translates or otherwise frequency converts the offset forward link signals to the RF transmit band occupied by the wireless communication system if frequency translation of the forward link signals distributed by the wired distribution system is desired. In one embodiment, the offset forward link signals are upconverted to an RF transmit band using a mixer driven by a fixed frequency local oscillator.

After frequency translating the forward link signals, the radio access device transmits the signals to the coverage area serviced by the radio access device. In one embodiment, the radio access device utilizes a transmitter and antenna to wirelessly broadcast the forward link signals over a limited service area, such as an area within close proximity to the home in which the CATV set top box resides.

The radio access device proceeds to block 530 and performs reverse link and uplink processing. The radio access device receives a wireless reverse link signal in an RF receive band of the wireless communication system. The radio access device can include, for example, a receiver that is coupled to the antenna that is shared with the transmitter that is used for the forward link.

The radio access device proceeds to block 540 and compares a signal metric value generated from the received reverse link signals to a predetermined threshold. In one embodiment, the signal metric value is a power of the received reverse link signals and the predetermined threshold is based on a noise threshold. The noise threshold can be, for example, a thermal noise value, and the predetermined threshold can be a value over the thermal noise.

The radio access device proceeds to decision block 542 and determines if the signal metric value exceeds the predetermined threshold. If not, the radio access device proceeds to block 560 and inhibits further reverse link processing. For example, the radio access device can control a switch setting to inhibit coupling the reverse link signals to a remainder of the uplink processing path in the radio access device. In another example, the radio access device can blank or otherwise attenuate the reverse link signals. The radio access device then proceeds to block 570.

If, at decision block 542 the radio access device determines that the signal metric value exceeds the predetermined threshold, the radio access device proceeds to block 550. At block 550, the radio access device continues uplink processing of the received signals and frequency converts the reverse link signals to generate frequency translated reverse link signals in the uplink band supported by the wired distribution system. In one embodiment, the radio access device can utilize a mixer driven by the same fixed local oscillator used to frequency convert the forward link signals as the reverse link frequency translator. In another embodiment, the radio access device can utilize a mixer driven by a fixed local oscillator that is distinct from the local oscillator used by the forward link translator.

The radio access device proceeds to block 554 and combines the frequency translated reverse link signals with the wired uplink content, which can include the uplink signaling and information typically communicated in the uplink direction within a CATV system. The radio access device can, for example sum the frequency translated reverse link signals with the wired uplink content or otherwise multiplex the content to generate a composite reverse link signal or composite uplink signal.

The radio access device proceeds to block 570 and transmits or otherwise communicates the composite reverse link signals along the wired distribution system. Thus, the radio access device can generate any one of four possible uplink signal configurations. The simplest configuration is the condition in which neither CATV uplink signals nor frequency translated reverse link signals are communicated by the radio access device along the uplink direction. In another conditions, one of the CATV uplink signals or frequency translated reverse link signals are communicated by the radio access device along the uplink direction. In another condition, both CATV uplink signals and frequency translated reverse link signals are communicated by the radio access device along the uplink direction. The radio access device is able to dynamically configure the uplink signaling to reflect the uplink signaling requirements, and does not unnecessarily contribute noise in the frequency band of the wireless communication signals when no reverse link signal is present.

Methods and apparatus are described herein for implementing a distributed antenna based on a wired communications system. A base station can utilize a wired distribution system to interface with a plurality of radio access devices that form elements of the distributed antenna. Each radio access device can selectively determine whether to communicate the locally received reverse link signals based on a comparison of a signal metric value determined from the received reverse link signals to a predetermined threshold. In one embodiment, the radio access device makes the reverse link decision based on exceeding a predetermined rise-over-thermal threshold.

As used herein, the term coupled or connected is used to mean an indirect coupling as well as a direct coupling or connection. Where two or more blocks, modules, devices, or apparatus are coupled, there may be one or more intervening blocks between the two coupled blocks.

The various illustrative logical blocks, modules, and circuits described in connection with the embodiments disclosed herein may be implemented or performed with a general purpose processor, a digital signal processor (DSP), a Reduced Instruction Set Computer (RISC) processor, an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method, process, or algorithm described in connection with the embodiments disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The above description of the disclosed embodiments is provided to enable any person of ordinary skill in the art to make or use the disclosure. Various modifications to these embodiments will be readily apparent to those of ordinary skill in the art, and the generic principles defined herein may be applied to other embodiments without departing from the spirit or scope of the disclosure. Thus, the disclosure is not intended to be limited to the embodiments shown herein but is to be accorded the widest scope consistent with the principles and novel features disclosed herein.

What is claimed is:

1. A method of signal distribution, the method comprising:
multiplexing a wireless communication forward link signal with a wired communication system content to generate an aggregate forward link signal;
distributing the aggregate forward link signal across a wired distribution system to a plurality of radio access devices; and
receiving from the wired distribution system a subset of frequency translated wireless communication reverse link signals selectively transmitted by a subset of the plurality of radio access devices based in part on a reverse link signal power received at each of the subset of the plurality of radio access devices.

2. The method of claim 1, wherein the wireless communication forward link signal comprises a frequency offset wireless communication forward link signal.

3. The method of claim 2, wherein multiplexing the wireless communication forward link signal with wired communication system content comprises frequency division multiplexing the frequency offset wireless communication forward link signal with television signals.

4. The method of claim 1, wherein distributing the aggregate forward link signal comprises distributing the aggregate forward link signal across a cable distribution system.

5. The method of claim 1, wherein receiving the frequency translated wireless communication reverse link signals selectively transmitted by the subset of the plurality of radio access devices comprises receiving a frequency translated reverse link signal from each of the subset of the plurality of radio access devices for which the received reverse link signal exceeds a predetermined threshold by a predetermined amount.

6. The method of claim 5, wherein the predetermined threshold comprises a thermal noise threshold.

7. A method of signal distribution, the method comprising:
receiving from a wired distribution system an aggregate forward link signal;
wireless transmitting a forward link signal based on at least a portion of the aggregate forward link signal using an antenna;
receiving, via the antenna, a reverse link signal; and
selectively coupling a frequency translated reverse link signal to the wired distribution system based on the reverse link signal.

8. The method of claim 7, wherein selectively coupling the frequency translated reverse link signal comprises:
comparing a signal metric value based on the reverse link signal to a predetermined threshold;
determining the signal metric value exceeds the predetermined threshold;
frequency converting the reverse link signal to the frequency translated reverse link signal; and
transmitting the frequency translated reverse link signal along a reverse link of the wired distribution system.

9. The method of claim 8, wherein comparing the signal metric value based on the reverse link signal to the predetermined threshold comprises comparing a reverse link signal power to a thermal noise value and determining a rise over thermal value.

10. The method of claim 8, further comprising combining the frequency translated reverse link signal with uplink cable television signals to generate a composite uplink signal, and
wherein transmitting the frequency translated reverse link signal comprises transmitting the composite uplink signal.

11. The method of claim 7, wherein selectively coupling the frequency translated reverse link signal comprises:
comparing a signal metric value based on the reverse link signal to a predetermined threshold;
determining the signal metric value does not exceed the predetermined threshold; and
inhibiting transmission of the reverse link signal along a reverse link of the wired distribution system.

12. The method of claim 7, wherein receiving the aggregate forward link signal comprises:
receiving a cable television signal; and
receiving a frequency offset forward link wireless communication signal frequency division multiplexed with the cable television signal.

13. The method of claim 7, wherein wireless transmitting the forward link signal comprises:
demultiplexing a frequency offset forward link wireless communication signal from a cable television signal;
frequency translating the frequency offset forward link wireless communication signal to the forward link signal; and
coupling the forward link signal to an antenna.

14. A signal distribution system, the system comprising:
a plurality of radio access devices, each radio access device including a wireless receiver configured to receive reverse link signals;
a comparator configured to compare a signal metric value based on the reverse link signal to a predetermined threshold;
a wired distribution system configured to receive a composite uplink signal and distribute the signal to a headend; and
a switch coupled to the radio access device and configured to selectively couple a signal based on the reverse link signals to the composite uplink signal.

15. The system of claim 14, wherein each radio access device further comprises a detector coupled to the wireless receiver and configured to determine a receive power as the signal metric value.

16. The system of claim 14, wherein each radio access device further comprises a forward link demultiplexer configured to demultiplex a frequency offset forward link signal from an aggregate downlink signal distributed by the wired distribution system.

17. The system of claim 16, wherein the aggregate downlink signal comprises cable television content frequency division multiplexed with the frequency offset forward link signal.

18. The system of claim 16, wherein each radio access device further comprises:
a forward link frequency translator configured to frequency convert the frequency offset forward link signal to a forward link signal in an RF transmit band of a wireless communication system; and
a transmitter configured to wirelessly transmit the forward link signal.

19. The system of claim 14, wherein each radio access device further comprises a reverse link frequency converter configured to frequency convert the reverse link signals to a frequency band within a frequency band of the composite uplink signal.

20. The system of claim 14, further comprising a thermal noise calibrator configured to determine a noise threshold, and wherein the predetermined threshold is based on the noise threshold.

21. A radio access device in a signal distribution system, the radio access device comprising:
a multiplexer/demultiplexer configured to receive an aggregate downlink signal from a headend and distributed by a wired distribution system, the demultiplexer configured to demultiplex a frequency offset forward link signal from a cable television content in the aggregate downlink signal;
a forward link frequency translator configured to frequency convert the frequency offset forward link signal to a forward link signal in an RF transmit band of a wireless communication system;
a transmitter coupled to the forward link frequency translator and configured to wirelessly transmit the forward link signal;
a receiver configured to receive a wireless reverse link signal;
a signal metric module coupled to an output of the receiver and configured to generate a signal metric value based on the reverse link signal;
a comparator configured to compare the signal metric value to a predetermined threshold; and
a switch coupled to the output of the receiver, the switch configured to selectively couple the reverse link signal to an uplink path based on a comparator output.

22. The radio access device of claim 21, further comprising:
a reverse link frequency translator coupled to the switch and configured to frequency convert the reverse link signal coupled to the uplink path to a frequency translated reverse link signal, and configured to couple the frequency translated reverse link signal to the multiplexer/demultiplexer; and
a cable uplink processor configured to couple a cable system uplink signal to the multiplexer/demultiplexer, and
wherein the multiplexer/demultiplexer multiplexes the frequency translated reverse link signal with the cable system uplink signal and transmits a multiplexed uplink signal on an uplink path of the wired distribution system.

23. The radio access device of claim 21, wherein the signal metric module comprises a power detector.

24. The radio access device of claim 21, wherein the predetermined threshold comprises a threshold based on a rise-over-thermal.

25. A signal distribution system, the system comprising:
means for multiplexing a frequency offset wireless communication forward link signal with a wired communication system content to generate an aggregate forward link signal;
means for distributing the aggregate forward link signal across a wired distribution system to a plurality of radio access devices; and
means for receiving from the wired distribution system a subset of frequency translated wireless communication reverse link signals selectively transmitted by a subset of the plurality of radio access devices based in part on a reverse link signal power received at each of the subset of the plurality of radio access devices.

26. A radio access device in a signal distribution system, the radio access device comprising:
means for receiving from a wired distribution system an aggregate forward link signal;
means for wireless transmitting a forward link signal based on at least a portion of the aggregate forward link signal using an antenna;
means for receiving, via the antenna, a reverse link signal; and
means for selectively coupling a frequency translated reverse link signal to the wired distribution system based on the reverse link signal.
